(19) United States
(12) Patent Application Publication
(10) Pub. No.: US 2002/0150867 A1
(43) Pub. Date: Oct. 17, 2002

(54) System and method for generating a directory structure in an on-line web environment

(75) Inventor: Thomas M. Sirhall, Littleton, CO (US)

Correspondence Address: LAHIVE & COCKFIELD, 28 STATE STREET, BOSTON, MA, 02109, US

(73) Assignee: Sun Microsystems Inc.

(21) Appl. No.: 09/832,532

(22) Filed: Apr. 11, 2001

(51) Int. Cl. G09B 19/00

(52) U.S. Cl. 434/118

(57) ABSTRACT

A system and method for generating an online network educational course is provided. A software tool utilizes a graphical user interface (GUI) to communicate with a third party. The GUI provides a straightforward and efficient mechanism for generating a software-based educational course file directory structure for an online environment. The GUI manages the receiving of a collection of data, and the software tool implements the generation of files for configuring, launching, and operating the educational course within a predetermined environment on the network.

### FIELD OF THE INVENTION

The invention generally relates to software, and more particularly relates to a software tool having a graphical user interface suitable for receiving information from a third party relating to an online course and generating the necessary files for, configuring, launching, and operating an online course under predefined parameters.

### BACKGROUND OF THE INVENTION

Some institutions currently offer education courses on-line, either as software to install directly on a stand-alone personal computer, or on a network (e.g., a local area network, or the Internet) for access by multiple computers and systems. Such on-line courses offer many benefits, including the ability of a student to avoid a commute to a traditional classroom setting, and the ability of a student to participate in a course in a more comfortable setting at the student's own pace and at convenient times. On-line educational courses may also attract more students to enroll.

To create, configure, generate, operate, and support online educational courses can require a significant amount of infrastructure and money. Therefore, there is a need for an entity, like a university or corporation, to be able to place one or more educational courses online. There exists a further need to make it possible for third-party entities to be able to create educational courses in a straightforward and efficient manner, without the significant monetary and time investment required to form their own online educational system, but by using a previously created online educational system. Such third parties further should be able to create such educational courses without the need for an extensive programming knowledge, or the need for creating such courses from scratch.

### SUMMARY OF THE INVENTION

There exists a need for a web-based learning center electronic device in communication with an on-line network, the web-based learning center electronic device implementing a method for enabling a third party to create file directory structure to support an on-line educational course.

The method provides at least one graphical user interface (GUI) accessible by an electronic device of the third party over the on-line network. A software tool, such as a JAVA applet, instructs the third party to provide a collection of data relating to the on-line educational course. The software tool implements a file directory structure on the third party electronic device based at least partially on the collection of data. For example, the applet may execute a series of predetermined instructions based a least partially on the collection of data to instruct the third party electronic device to generate a file directory structure suitable for implementation in conjunction with the web-based learning center. The file directory structure supports the on-line educational course. The file directory structure is suitable for supporting the on-line educational course through the web-based learning center.

In a third party electronic device, a method is provided for generating a file structure for supporting an on-line educational course. The method includes the step of providing a communication link through a network to a web-based learning center electronic device. For example, a network connection can be established through a network interface of a third party electronic device.

The method continues with receiving a software tool for interacting with the web-based learning center electronic device. The software tool executes the steps of displaying a graphical user interface on the third party electronic device for interfacing with the web-based learning center electronic device, collecting data through the graphical user interface, and generating a directory structure of files for supporting the educational course within a web-based learning center environment. For example, the collecting step of the method can include receiving data input from the JAVA applet as entered through the graphical user interface. In further example, the generating step of the method can include the third party electronic device internally creating the structure of files.

The method can further include the step of entering a URL into a browser to direct the network connection.

The receiving step of the method includes downloading the software tool in the form of a JAVA applet. JAVA is a trademark and/or registered trademark of Sun Microsystems, Inc. of Mountain View, Calif., in the United States and in other countries. However, any number of suitable programming languages can be used to code the software tool.

According to one embodiment of the illustrated invention, in an electronic device, a software tool is provided for interacting with a web-based learning center through a network. The software tool has a graphical user interface suitable for collecting data. The software tool generates files for configuring, launching, and operating the educational course compatible with the web-based learning center on the network.

The electronic device software tool can be in the form of a JAVA applet. The electronic device software tool can receive data in the form of information relating to the educational course. The information received can include information relating to the educational course, system requirements for supporting and operating the educational course, and/or support information relating to said educational course. The information can be submitted in at least one of HTML and XML formats.

In accordance with a further aspect of the illustrated invention, an automated method of configuring an educational course file directory structure on an electronic device is provided. The method includes the following steps. Upon action of a third party to add said course, the method creates a new course object containing information pertaining to the course. Utilizing a previously created company object, the method carries out the steps of creating a new directory with a course marking identifier, creating an images directory within the new directory, creating a text directory within the new directory, obtaining company information, creating files to be placed in the text directory, creating definition and properties course files and placing the definition and properties course files in a course root directory, and creating an xvendor directory having a properties directory containing a company properties file.

The method can continue by creating a Jarer class to create a jar file, according to one aspect of the present invention. A “Jarer class” is a class within JAVA that is utilized in creating jar files, which are compressed versions of JAVA files, suitable for transporting over a network, such as the Internet.

The step of creating a new directory with a course marking identifier can comprise identifying the course with a previously assigned marketing number, according to another aspect of the present invention. The “marketing number” is simply an identifier assigned by the marketing department of the host company, and attributed to the particular third party vendor. The marketing number can, however, be any type of identifier either previously attributed by a segment of the host company, or some other identifying character or characters.

The step of obtaining company information can further comprise copying a company logo utilizing a fileCopy class and placing the company logo copy in the images directory for each course, according to another aspect of the present invention.

### BRIEF DESCRIPTION OF THE DRAWINGS

The aforementioned features and advantages, and other features and aspects of the present invention, will become better understood with regard to the following description and accompanying drawing, wherein:

FIG. 1 is a diagrammatic illustration of an example electronic device according to one aspect of the present invention;

FIG. 2 is a diagrammatic illustration of a network according to one aspect of the present invention;

FIG. 3A is a diagrammatic flowchart of a process for entering data into a network for an online educational course according to one aspect of the present invention;

FIG. 3B is an illustration of an example graphical user interface according to one embodiment of the present invention; and

FIG. 4 is a diagrammatic flowchart of a method of creating an online educational course according to one aspect of the present invention.

### DETAILED DESCRIPTION OF THE INVENTION

The present invention generally relates to a software tool that provides a mechanism by which a provider of an online, or web-based, network learning center can enable a third party to easily submit data and information to create and support an educational course in an online network learning center environment. The third party educational course combines with other educational courses in a learning center on the network. Regardless of the source of information, the resulting educational courses can all maintain a similar look, feel, and operating structure in accordance with parameters set forth by the provider of the online learning center (the host company). The software tool makes it possible for the third party submitters, or vendors, to provide one or more courses of their own content, while still in keeping with the setup or parameters, including look and feel, of the existing learning center. The information provided is automatically transformed into a useable online educational course.

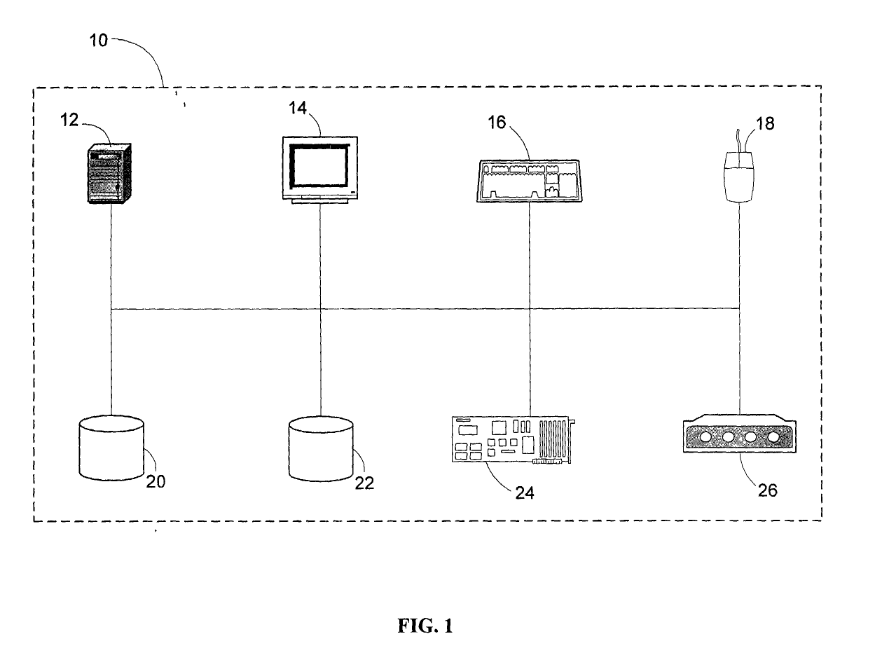

FIGS. 1-4, wherein like parts are designated by like reference numerals throughout, illustrate example embodiments of a software tool suitable for interacting with a user or third party to ultimately create an online educational course according to aspects of the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, language, interface, or type of elements or materials utilized, in a manner still in keeping with the spirit and scope of the present invention.

The present invention is designed for use with an on-line educational learning center. The learning center provides on-line opportunities for students to enroll in educational courses pertaining to any number of different subject areas, and follow through an on-line course to learn the particular subject matter. Courses that exist within the on-line learning center can be provided by the creator and host of the learning center, or can be provided by third parties (e.g., universities or vendors). A third party wishing to submit and create a course for the on-line learning center can access a learning center website, utilizing a browser such as the HOTJAVA browser made by Sun Microsystems, Inc., INTERNET EXPLORER made by Microsoft Corporation, or NETSCAPE made by Netscape Communications. The:browser utilized, for the purposes of the embodiments illustrated herein, supports the JAVA language so that the third party can communicate with the on-line learning center. More specifically, a JAVA applet guides the third party through the process of creating an on-line course within the on-line learning center structure.

The aforementioned web browsers work by retrieving and executing web pages. The web pages are usually stored on a web server accessible over a network. The web pages are written in a markup language such as Hypertext Markup Language (HTML) or Extensible Markup Language (XML) and contain information which is interpreted for display to a user by the web browser.

HTML is a markup language that encodes a document via the use of tags and attributes. Tags appear between < > brackets, and attributes are specified in the form of “name=value”. HTML specifies the meaning of each tag and attribute and how text located between tags and/or attributes will appear. An example is a tag <p>, which designates the beginning of a new paragraph. A corresponding tag </p> designates the end of the paragraph. HTML interpreters found in web browsers typically interpret HTML documents.

XML provides greater flexibility for applications utilizing electronic documents. Similar to HTML, XML is a markup language that uses tags and attributes, but unlike HTML, XML uses tags only to delimit pieces of data. The interpretation given to the meaning of the data is left up to the application that reads the data. As noted above, the tag <p> in HTML specifies that a new paragraph is needed, whereas the tag <p> in XML has an application specific meaning. This flexibility allows applications making use of the data to interpret the data in different ways. The presentation of the data is separated from the content. Web browsers equipped with XML interpreters can translate and present XML web pages.

Conventionally, a user launches a web browser to view web pages over a network. The web browser may be part of an application suite, or it may be a stand-alone application, such as those previously mentioned. The browser retrieves the web page, interprets it, and displays it to a user. While interpreting the web page, the browser may encounter an indication of an embedded “applet”. The indication is typically a tag labeled “<applet>”. An “applet” is a program designed to be executed from within another application. Applets enable web pages to include advanced effects, such as moving graphics and sound. Applets may be written in many languages, but many of them are written in JAVA.

Once the web browser interpreter encounters a JAVA applet, the browser retrieves the code for the applet from an indicated source. The source for the applet may be the original location of the web page, which is often a web server. Alternatively, the source may be a different remote source accessible over the network for which a uniform resource locator (URL) address is provided. The retrieved code is fed to the JAVA Virtual Machine (JVM) for execution. The result of the code execution is included by the web browser in the display presented to the user. This embedding of code enables whole programs to be included within a single web page merely by including a small applet to indicate the code source.

FIG. 1 illustrates one example embodiment of an electronic device 10 suitable for practicing the illustrative embodiment of the present invention. The electronic device 10 is representative of a number of different technologies, such as personal computers (PCs), laptop computers, workstations, personal digital assistants (PDAs), Internet appliances, cellular telephones, and the like. In the illustrated embodiment, the electronic device 10 includes a central processing unit (CPU) 12 and a display device 14. The display device 14 enables the electronic device 10 to communicate directly with a user through a visual display. The electronic device 10 further includes a keyboard 16 and a mouse 18. Other potential input devices not depicted include a stylus, trackball, joystick, touch pad, touch screen, and the like. The electronic device 10 includes primary storage 20 and secondary storage 22 for storing data and instructions. The storage devices 20 and 22 can include such technologies as a floppy drive, hard drive, tape drive, optical drive, read only memory (ROM), random access memory (RAM), and the like. Applications such as browsers, JAVA virtual machines, and other utilities and applications can be resident on one or both of the storage devices 20 and 22. The electronic device 10 also includes a network interface 24 for communicating with one or more electronic devices external to the electronic device 10 depicted. A modem 26 is one form of establishing a connection with an external electronic device or network. The CPU 12 has either internally, or externally, attached thereto one or more of the aforementioned components.

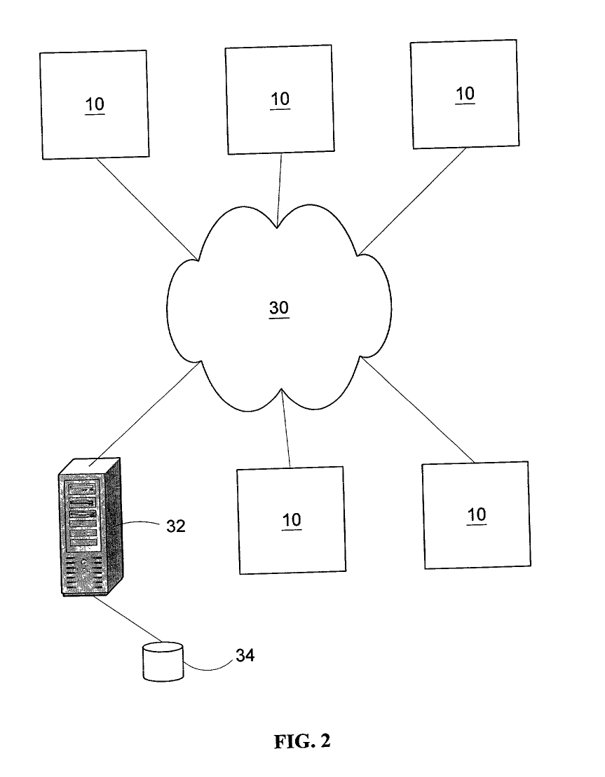

FIG. 2 illustrates one example embodiment of a network 30 to which the electronic device 10 can be connected. The network has connected thereto a plurality of client electronic devices 10, and at least one server 32. Each client device 10 contains one or more software applications such as a JAVA Virtual Machine, a web browser able to run at least one of HTML and XML mark up languages, or another software application that enables the communication of the client device 10 with the network 30. The browser application is one example application that enables the client device 10 to communicate with the network 30. Located at a distal location within the network 30 from the plurality of electronic devices 10 is at least one server 32. The server contains one or more software applications as well, such as JAVA Virtual Machine, a web browser able to run at least one of HTML and XML mark up languages, or another software application for enabling network communication. The server 32 additionally includes at least one data storage unit for storing data in the form of, e.g., a database 34 containing information to be disbursed to one or more of the plurality of client electronic devices 10 across the network 30.

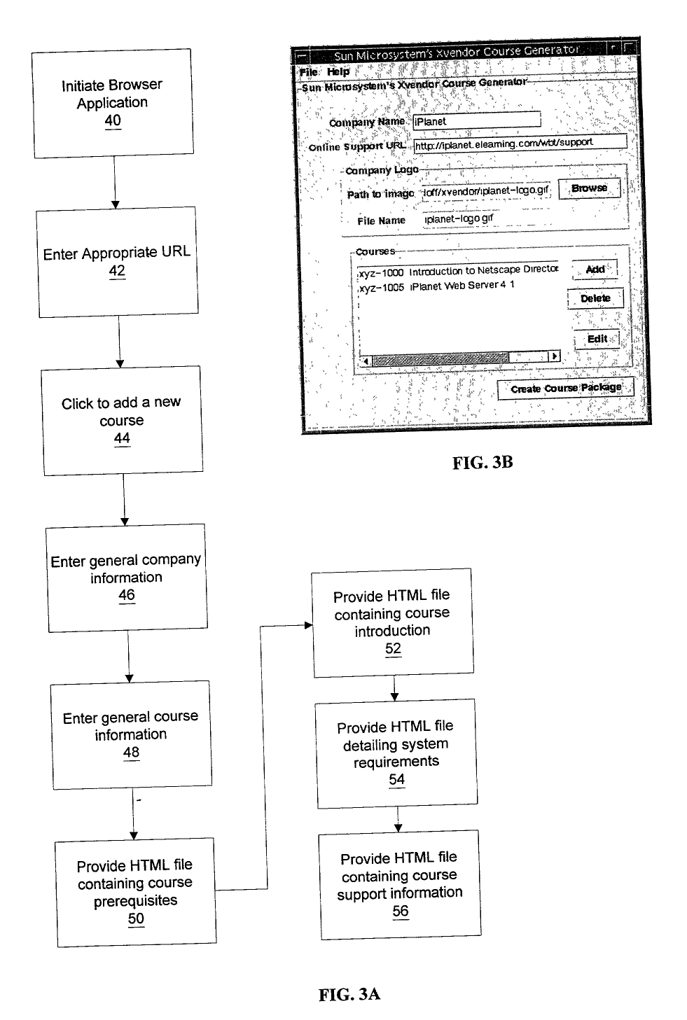

FIG. 3A illustrates a method by which a third party can add a new course to the on-line web learning center. The third party first navigates to the appropriate web page, or location, on the network hosting the online learning center. The network can be a local area network, an intranet, an extranet, or can be a more global network such as the Internet. The third party, to navigate to the appropriate web page, first starts a browser application (step 40) if one is not already running. The third party enters the appropriate uniform resource locator (URL) address for the desired web location (step 42). The third party's browser arrives at the URL designated for adding a new course to the on-line web learning center. In particular, the browser sends an http request for the web page to which the server responds by sending the web page for the specified URL.

The web page provides a GUI for the third party to utilize while entering information and utilizing the JAVA applet software tool. An example third party interface screen is illustrated in FIG. 3B. This is merely one example of how a GUI can appear to the third party. One of ordinary skill in the art comprehends that the GUI may take any number of different forms while still conveying the desired information and carrying out the desired actions in accordance with embodiments of the present invention.

The third party initiates the process to add a new course by, e.g., clicking on a button entitled “add new course” (step 44). The third party is led to a screen, i.e., a new web page, requiring general company information from the third party. The third party enters the required information, such as company name, on-line support URL, company logo, and any other contact information (step 46). The company logos can be in graphic files having, e.g., .GIF or .JPG formats or some other format readable by the web on-line learning center. One of ordinary skill in the art will understand that each of the specific parameters, such as logo dimensions, can be altered through use of different programming languages, formats, applications, and the like, and the specific parameters disclosed herein are therefore merely illustrative.

The third party clicks on a button entitled “Create Course Package” and is led to a screen for adding the course information, where course specific information is entered for each course that is being created. The software tool directs the display of the course specific data entry web page for the third party to add requisite information. The third party enters general course information (step 48), such as the course title, a marketing assigned number, a course URL leading to the courses start page, and a course support URL, if desired. The course information required is outlined by the host company when creating the online network, and the information required can vary, depending on what information the company desires.

The third party provides an HTML file containing the course prerequisites (step 50). The HTML format as utilized herein means the HTML forma as well as other applicable mark up languages such as, XML, as understood by one of ordinary skill in the art. The applicant does not intend to limit the present invention to utilizing only HTML formatted files, but rather intends the discussion of HTML files herein to illustrate only one embodiment of the present invention.

The third party enters the HTML formatted text that details the prerequisites specific to the course (e.g., other prerequisite courses, basic skills, or required experience). Typically this section is offered in paragraph format with bulleted lists, but can be in any number of different formats.

The third party provides an HTML file containing course introduction information (step 52). The third party enters the HTML formatted text introducing the course (e.g., modules that are covered, topics that are covered, technology that is covered, and the like). Most commonly, this section is also offered in paragraph format with bulleted lists, but can be formatted differently.

The third party proceeds with providing an HTML file detailing system requirements (step 54). The third party enters the HTML formatted text detailing the course system requirements, such as which browsers, plug-ins, JAVA enabled, audio, and the like, are supported. This section is most commonly authored utilizing lists, but can be in any desired format.

The third party provides an HTML file containing course support information (step 56). The third party enters the HTML formatted text presenting the course support information, such as WBT support websites, email allises, phone numbers and the like. Typically, this section is offered in paragraph format, but can be in a number of different formats. WBT Systems is a corporation offering products and services relating to the creation and delivery of training or courses on the Internet. The WBT support websites work in conjunction with such entities as online web learning centers.

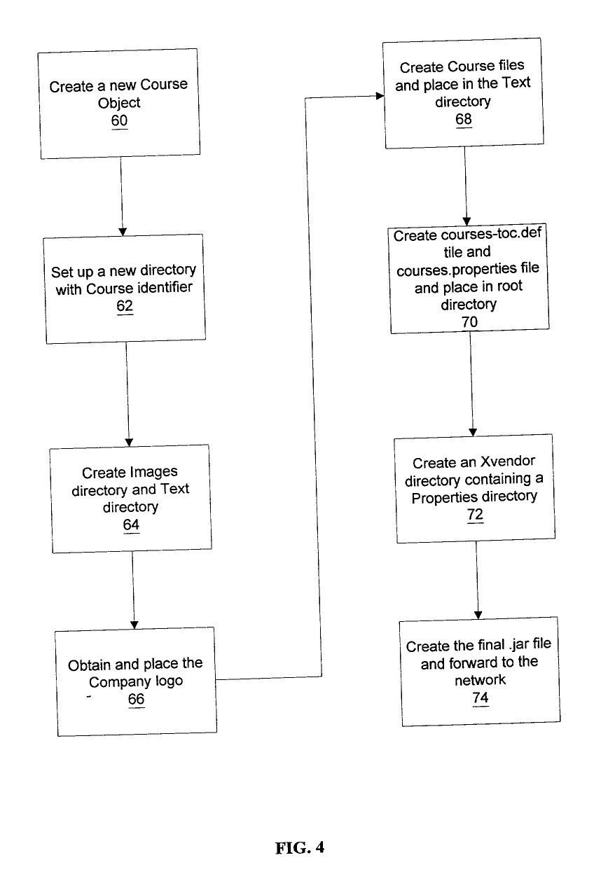

Once all of the information has been provided by the third party, the software tool proceeds to create the structure for the new course, as illustrated in FIG. 4. The software tool begins by creating a new course object (step 60). Each course object contains the information pertaining to a specific course.

The software tool proceeds to set up a new directory with a course identifier (step 62). The course identifier can be for example, the marketing member attributed to the third party as previously mentioned.

The software tool creates an images directory and a text directory (step 64). The images directory primarily serves to store images relating to the on-line course, while the text directory primarily serves to store related text.

The software tool continues by obtaining and placing the company logo into the images directory for each course (step 66). The company logo is copied using, e.g., a fileCopy class written in JAVA. The fileCopy class is a JAVA-based utility class that enables the copying of files such as JPEG, or PDF files, from one location to be placed in another directory location.

The software tool creates course files and places them in the text directory (step 68). The course files can be HTML files relating to course title, course introduction, course requirements, support information, and any other information deemed necessary by the third party.

The software tool proceeds to create a course-TOC.DEF file and a course .PROPERTIES file and place them in the course name route directory (step 70). The course-TOC.DEF file tells the web online learning center engine the course title and a unique ID number so that the course can be placed into a database in the web online learning center. The course.PROPERTIES file gives information about the course such as the actual link to the course itself, and window sizes.

After the software tool has completed creating the various files through use of the course object, a company object makes a directory called XVENDOR and within that creates a directory called PROPERTIES (step 72). A COMPANY.PROPERTIES file is created in the PROPERTIES directory from the company information. The COMPANY.PROPERTIES file contains the previously entered company information, as well as information concerning where there support page is, and other relevant information. The file also defines many default parameters for each of the courses sponsored by the company.

In a final step, a Jarer class is called to create a final Jarer file that the third party will send to the read learning center. The Jarer file is a compressed version of all of the information entered by the third party. The Jarer class takes the entire directory structure and files and forms the Jarer file that keeps the directory structure in tact so that when the web learning center extracts the files, the identical directory structure is created on the web learning center side of the network.

Numerous modifications and alternative embodiments of the invention will be apparent to those skilled in the art in view of the foregoing description. Accordingly, this description is to be construed as illustrative only and is for the purpose of teaching those skilled in the art the best mode for carrying out the invention. Details of the structure, and steps, may vary substantially without departing from the spirit of the invention, and exclusive use of all modifications that come within the scope of the appended claims is reserved. It is intended that the invention be limited only to the extent required by the appended claims and the applicable rules of law.

What is claimed is:

1. In an electronic device in communication with an on-line network, a method for enabling a third party to create file directory structure to support an on-line educational course, said method comprising the steps of:
providing at least one graphical user interface accessible by an electronic device of said third party over said on-line network;
instructing said third party to provide a collection of data relating to said on-line educational course; and
implementing a file directory structure on said electronic device based at least partially on said collection of data, said file directory structure being suitable for supporting said on-line educational course through said web-based learning center.

2. The method of claim 1, wherein said providing step comprises providing a Java-based applet software tool suitable for execution on said third party electronic device.

3. The method of claim 2, wherein said instructing step comprises said applet executing a series of instructions directing said third party in the entry of said collection of data.

4. The method of claim 2, wherein said implementing step comprises said applet executing a series of predetermined instructions based a least partially on said collection of data to instruct said electronic device to generate a file directory structure suitable for implementation in conjunction with said web-based learning center to support said on-line educational course.

5. In a third party electronic device, a method for generating a file structure for supporting an on-line educational course, said method comprising the steps of:
providing a communication link through a network to a web-based learning center electronic device;
receiving a software tool for interacting with said web-based learning center electronic device, said software tool executing the steps of:
displaying a graphical user interface on said third party electronic device for interfacing with said web-based learning center electronic device;
collecting data through said graphical user interface; and
generating a directory structure of files for supporting said educational course within a web-based learning center environment.

6. The method of claim 5, wherein said providing a communication link comprises establishing a network connection through a network interface of said third party electronic device.

7. The method of claim 6, further comprising the step of entering a URL into a browser to direct said network connection.

8. The method of claim 5, wherein said receiving step comprises downloading said software tool in the form of a JAVA applet.

9. The method of claim 5, wherein said collecting step comprises receiving data input from said JAVA applet as entered through said graphical user interface.

10. The method of claim 5, wherein said generating step comprises said third party electronic device internally creating said structure of files.

11. An electronic device, comprising:
a display;
a software tool for interacting with a web-based learning center through a network, said software tool comprising:
user interface elements suitable for collecting data;
wherein said software tool generates files for configuring, launching, and operating said educational course compatible with said web-based learning center on said network.

12. The electronic device of claim 11, wherein said software tool is in the form of a JAVA applet.

13. The electronic device of claim 11, wherein said software tool receives data in the form of information relating to said educational course.

14. The electronic device of claim 13, wherein said information comprises information relating to said educational course.

15. The electronic device of claim 13, wherein said information comprises system requirements for supporting and operating said educational course.

16. The electronic device of claim 13, wherein said information comprises support information relating to said educational course.

17. The electronic device of claim 13, wherein said information is submitted in one of HTML and XML formats.

18. An automated method of configuring an educational course file directory structure on an electronic device, comprising the steps of:
upon action of a third party to add said course, creating a new course object containing information pertaining to said course;
utilizing a previously created company object to carry out the steps of:
creating a new directory with a course marking identifier;
creating an images directory within said new directory;
creating a text directory within said new directory;
obtaining company information;
creating files to be placed in said text directory;
creating definition and properties course files and placing said definition and properties course files in a course root directory; and
creating an xvendor directory having a properties directory containing a company properties file.

19. The method according to claim 18, further comprising the steps of:
creating a jarer class to create a .jar file.

20. The method according to claim 18, wherein said step of creating a new directory with a course marking identifier comprises identifying said course with a marketing number.

21. The method according to claim 18, wherein said step of obtaining company information comprises copying a company logo utilizing a fileCopy class and placing said company logo copy in said images directory for each course.

22. The method according to claim 18, wherein said step of creating files to be placed in said text directory comprises creating files relating to one or more of course prerequisites, course title, course introduction, course requirements, and course support information.

23. A computer readable medium containing a software tool for executing a method for enabling a third party to create file directory structure to support an on-line educational course in a network, said method comprising the steps of:
providing at least one graphical user interface accessible by an electronic device of said third party over said on-line network;
instructing said third party to provide a collection of data relating to said on-line educational course; and
implementing a file directory structure on said electronic device based at least partially on said collection of data, said file directory structure being suitable for supporting said on-line educational course through said web-based learning center.

24. The computer readable medium of claim 23, wherein said providing step of said software tool comprises providing a Java-based applet software tool suitable for execution on said third party electronic device.

25. The computer readable medium of claim 23, wherein said instructing step of said software tool comprises said applet executing a series of instructions directing said third party in the entry of said collection of data.

26. The computer readable medium of claim 23, wherein said implementing step comprises said applet executing a series of predetermined instructions based a least partially on said collection of data to instruct said electronic device to generate a file directory structure suitable for implementation in conjunction with said web-based learning center to support said on-line educational course.

27. A computer readable medium containing a software tool for interacting with a web-based learning center through a network, said software tool comprising:
user interface elements suitable for collecting data;
wherein said software tool generates files for configuring, launching, and operating an educational course compatible with said web-based learning center on said network.

28. The computer readable medium of claim 27, wherein said software tool is in the form of a JAVA applet.

29. The computer readable medium of claim 27, wherein said software tool receives data in the form of information relating to said educational course.

30. The computer readable medium of claim 29, wherein said information comprises information relating to said educational course.

31. The computer readable medium of claim 29, wherein said information comprises system requirements for supporting and operating said educational course.

32. The computer readable medium of claim 29, wherein said information comprises support information relating to said educational course.

33. The computer readable medium of claim 29, wherein said information is submitted in one of HTML and XML formats.
